(19) United States
(12) Patent Application Publication
(10) Pub. No.: US 2018/0027826 A1
(43) Pub. Date: Feb. 1, 2018

(54) Han-Burger and Making Method Thereof

(71) Applicant: Guang Hui GUAN, Temple City, CA (US)

(72) Inventor: Guang Hui GUAN, Temple City, CA (US)

(21) Appl. No.: 15/220,389

(22) Filed: Jul. 27, 2016

(51) Int. Cl. A21D 13/00; A23P 20/25

(52) U.S. Cl. CPC A21D 13/0029; A23P 20/25

(57) ABSTRACT

A method of making a han-burger includes the steps of: forming a burger shell by a dough to have a filling compartment and an opening, preparing a filling with predetermined ingredients and nutrition, and disposing the filling in the filling compartment of the burger shell through the opening thereof, preparing a thick viscous paste, and applying the thick viscous paste to seal the opening of the burger shell to enclose the filling in the filling compartment of the burger shell to form a food product. Accordingly, the thick viscous paste is made of mashed root crop food product which is soft enough to be deformed to match with the shape of the opening of the burger shell and is sticky enough to seal at the opening thereof.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a food product, and more particularly to a han-burger product, wherein a filling with variety kinds of stuffing can be sealed in a burger shell.

### Description of Related Arts

Broadly, the bun or crust usually made by variety kinds of dough and added different ingredients into the dough for different softness, tastes, or baking purposes. Traditionally the crust is prepared for containing filling within the crust, such as a pastry shell, bread crust, pie crust, or tart crust. Thus, the crust is able to be enjoyed with the variety of fillings or stuffing to form different kinds of food product, such as apple pie filled apple in the crust, crust with creamy chowder soup, or Asian style bread, such as bread crust with barbecue pork and soupy sauce.

In order to seal the stuffing within the crust, the stuffing is normally prepared and sealed into an original material of crust to form an integral bun product. For example, a stuffing of apple mix is usually filled within containing dough, then sealed by top sealing dough to seal the apple mix within the containing and top sealing dough, and then put it into an oven for baking the dough of the original material of crust and the stuffing of apple mix together, so as to form an integral apple pie. The apple pie can be served immediately once the apple pie is baked, or can be further packed to form a frozen product for later selling.

Some problems are frequently encountered in the process for preparation of the bun product. During baking a filled crust or shell product, the contact of moist stuffing with the surface of the original material such as dough, tends to absorb the moisture in the filling of stuffing. Moreover, the stuffing underlying the original material of the crust may remain undesirably moist and be undercooked. As a result of the contact between the moist stuffing and the surface of dough makes the contact surface of dough becomes tough and soggy, which is a main concern of the drawback of the existing bun product.

Mostly, the original material of crust or shell of the bun product, such as flour, starch, or dough, is heated by putting a layer of the original material of crust into a cavity of mold, so as to form a compartment shape within the original material for containing the stuffing therein. While heating the crust original material within the mold, the compartment surface of the crust is aroused, and becomes uneven and/or has some bubbles protruded out from the compartment surface. Thus, the phenomena not only shrinks the compartment containing space, but also undesirably arises the contact surface between the dough surface and the stuffing, so as to undesirably make the crust relatively more soggy.

In order to allow a user to conveniently and quickly enjoy the bun products anytime he or she wants, there are plenty of frozen crusts products are provided for the user to store it in their own freezer, and conveniently and quickly heat it up whenever they want. For making the frozen crusts products, lots of manufactures heated or cooked the crusts products filled with the stuffing in advance, then frozen and packed the cooked bun product for selling purpose.

However, after the contact between the dough surface and the stuffing while heating the bun product, and freezing and packing the bun product with the filled stuffing therein, the bun products tend to be even more undesirably soupy and tough.

U.S. Pat. No. 8,383,176, disclosed a “Han-burger and making method thereof” by the applicant, wherein the filling is filled in the burger shell and is enclosed by the burger cover. In particular, the burger cover further has a circumferential edge frictionally contacting with an inner side of the surrounding wall of the burger shell at the top opening to enclose the filling compartment. In other words, the size of the burger cover must match with the opening size of the burger shell. If the burger cover is smaller than the opening size of the burger shell, the burger cover cannot frictionally contact with the top opening of the burger shell. If the burger cover is bigger than the opening size of the burger shell, the burger cover cannot fit to enclose the top opening of the burger shell. Therefore, the manufacturing process of the han-burger will be complicated by matching the size of the burger cover with the opening size of the burger shell. There is an alternative way to improve the sealing effect of the burger cover and to simplify the manufacturing process of the han-burger.

### SUMMARY OF THE PRESENT INVENTION

The invention is advantageous in that it provides a han-burger and the making method thereof, wherein the filling can be sealed in a burger shell via a thick viscous paste.

Another advantage of the invention is to provide a han-burger and the making method thereof, wherein the thick viscous paste is soft enough to be deformed to match with the shape of the opening of the burger shell and is sticky enough to seal at the opening thereof.

Another advantage of the invention is to provide a han-burger and the making method thereof, wherein the amount of thick viscous paste can be selectively adjusted until the opening of the burger shell is sealed.

Another advantage of the invention is to provide a han-burger and the making method thereof, wherein the burger shell is pre-cooked to form a hardened surface for contacting with the filling so as to minimize the undesired moisture of the crust original material surface.

Another advantage of the invention is to provide a han-burger and the making method thereof, wherein the size of the opening of the burger shell is not larger than the diameter of the filling compartment thereof. Therefore, the thick viscous paste can be effectively sealed at the opening of the burger shell.

Another advantage of the invention is to provide a han-burger and the making method thereof, wherein the burger shell is made from bread to have an innovation way for the consumer to eat the Chinese food with bread.

Another advantage of the invention is to provide a han-burger and the making method thereof, wherein no expensive or complicated process is required to employ in the present invention in order to achieve the above mentioned objects. Therefore, the present invention successfully provides an economic and efficient solution for making a new way to have Chinese food that enables the consumer to have Chinese favor food encased in the burger shell with the thick viscous paste of the han-burger.

Additional advantages and features of the invention will become apparent from the description which follows, and may be realized by means of the instrumentalities and combinations particular point out in the appended claims.

According to the present invention, the foregoing and other objects and advantages are attained by a method of making a han-burger, which comprises the following steps.

(A) Form a burger shell by a dough to have a filling compartment and an opening.

(B) Prepare a filling with predetermined ingredients and nutrition, and dispose the filling in the filling compartment of the burger shell through the opening thereof.

(C) Prepare a thick viscous paste.

(D) Apply the thick viscous paste to seal the opening of the burger shell to enclose the filling in the filling compartment of the burger shell to form a food product.

In accordance with another aspect of the invention, the present invention comprises a han-burger, comprising:

a burger shell having a filling compartment and an opening;

a filling with predetermined ingredients and nutrition disposed in the filling compartment of the burger shell through the opening thereof; and

a thick viscous paste placed and sealed at the opening of the burger shell to enclose the filling in the filling compartment of the burger shell to form a food product.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow chart the method of preparing a han-burger with filling according to a preferred embodiment of the present invention.

FIG. 2 is a perspective view of the han-burger according to the above preferred embodiment of the present invention.

FIG. 3 is a sectional view of the han-burger according to the above preferred embodiment of the present invention.

FIGS. 4A and 4B illustrate different alternative shapes of the burger shell of the han-burger according to the above preferred embodiment of the present invention.

FIG. 5 is a schematic view of the han-burger according to the present invention, illustrating the method of preparing the han-burger.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

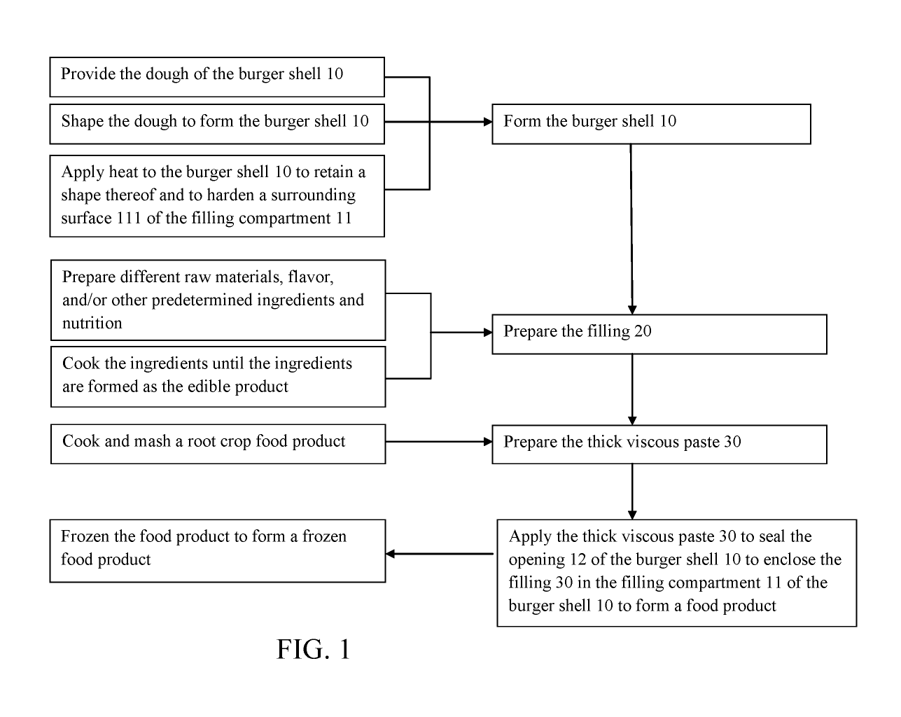

Referring to FIGS. 1 to 3 of the drawings, a han-burger and its making method thereof according to a preferred embodiment of the present invention is illustrated, wherein the han-burger comprises a burger shell 10, a filling 20, and a thick viscous paste 30.

The burger shell 10 has a filling compartment 11 and an opening 12, wherein the filling 20 with predetermined ingredients and nutrition is disposed in the filling compartment 11 of the burger shell 10 through the opening 12 thereof. Then, the thick viscous paste 30 is placed and sealed at the opening 12 of the burger shell 10 to enclose the filling 20 in the filling compartment 12 of the burger shell 10 to form a food product.

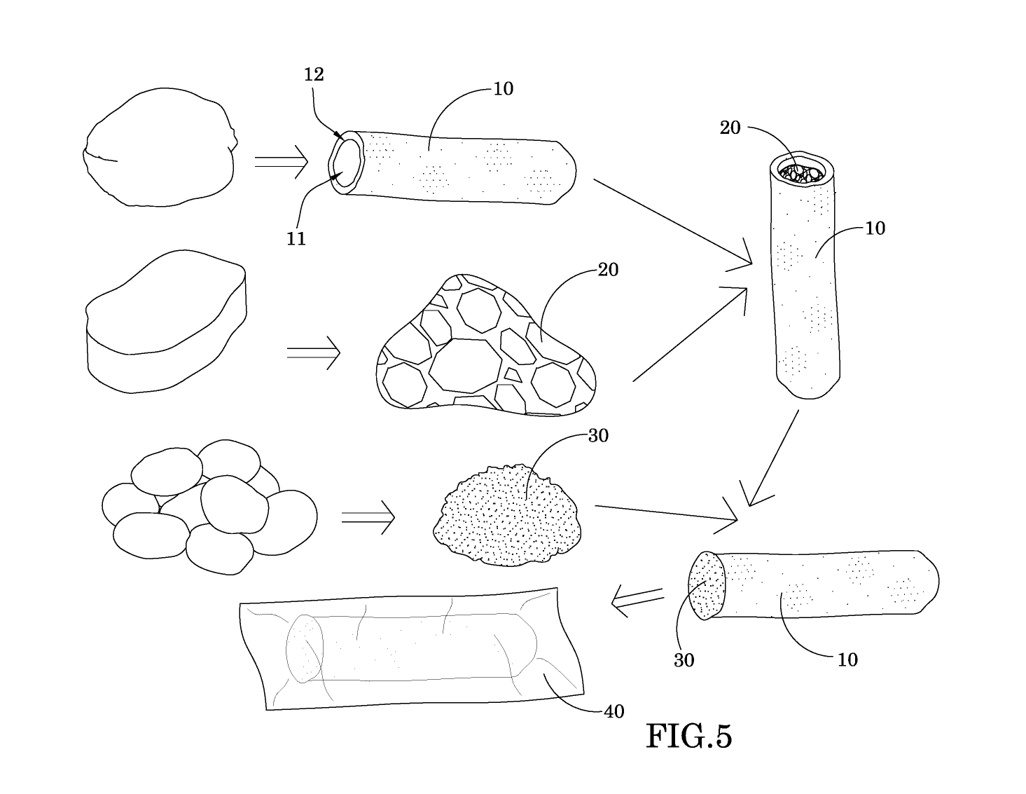

As shown in FIGS. 1 and 5, the present invention further discloses a making method of the han-burger which comprises the following steps.

(1) Form the burger shell 10 by a dough to have the filling compartment 11 and the opening 12.

(2) Prepare the filling 20 with predetermined ingredients and nutrition, and dispose the filling 20 in the filling compartment 11 of the burger shell 10 through the opening 12 thereof.

(3) Prepare the thick viscous paste 30.

(4) Apply the thick viscous paste 30 to seal the opening 12 of the burger shell 10 to enclose the filling 20 in the filling compartment 11 of the burger shell 10 to form a food product.

Accordingly, in the step (1), the burger shell is prepared by the following steps.

(1.1) Provide the dough of the burger shell 10. Accordingly, the dough of raw material of burger shell 10 has at least one ingredient mixed with the dough for different purposes, such as adding yeast for baking purpose, sugar, salt, butter, different types of flours etc. Kneading the mixture of dough may be applied to make the han-burger has a relatively better quality.

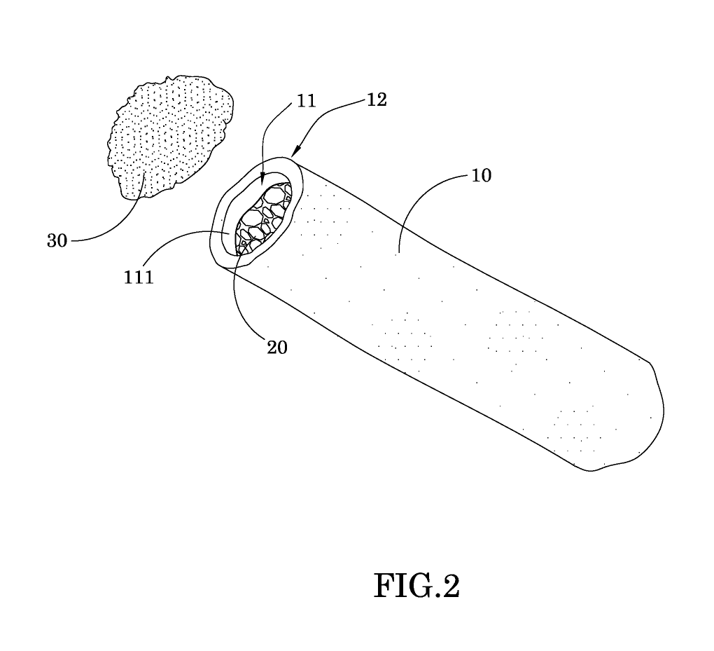

(1.2) Shape the dough to form the burger shell 10 having the filling compartment 11 and the opening 12. As shown in FIG. 2, the burger shell 10 is configured to have a tubular shape which has a closed end and an opposed opened end to form as the opening 12. Accordingly, the filling compartment 11 of the burger shell 10 has a uniform diameter size. It is worth mentioning that the tubular shaped burger shell 10 can be configured to have two opened ends, such that the burger shell 10 will have two openings 12. The thick viscous paste 30 will apply to the two openings 12 of the burger shell 10.

(1.3) Apply heat to the burger shell 10 to retain a shape thereof and to harden a surrounding surface 111 of the filling compartment 11 for moisture prevention of the burger shell 10. In other words, the burger shell 10 has the harden surrounding surface 111 of the filling compartment 11 for moisture prevention of the burger shell 10. It is appreciated that when the heat applied on the burger shell 10, the heat will make the inner surface and the outer surface of the burger shell 10 become harden, so that a harden layer occurred on the inner surface and outer surface of the burger shell 10 can decrease the undesirable soggy or soupy happened between the contact of the filling 20 and the inner surface, i.e. the surrounding surface 111, of the filling compartment 11.

Accordingly, the heat applied onto the burger shell 10 not only makes the harden surface of the burger shell 10, but also pre-cooks the burger shell 10 to a predetermined cooked level by controlling the heating temperature and the time. Thus, the burger shell 10 can be cooked until it half-done just for make the harden surface of the burger shell 10, so that the user is able to further cook the han-burger when the user is about to eat and turn the burger shell 10 into an edible product. The heat also can be applied on the burger shell 10 until the burger shell 10 is fully cooked to the edible product for enjoying the han-burger immediately, or for storing the han-burger for later use.

The heat can be supplied by an oven for baking purpose, so that the burger shell 10 is placed into the oven at a predetermined baking temperature for a predetermined baking time, such as 400° C. baking temperature for 10 minutes. It is worth to mention that the burger shell 10 should be placed on a shell mold during baking process to retain the inner surface of the burger shell 10. Moreover, the heat can also be supplied by a steam chamber, wherein the burger shell 10 is placed into the steam chamber at a predetermined temperature for a predetermined time, so as to turn the surrounding wall 111 of the filling compartment 11 of the burger shell 10 become harden.

Before the step (1.3) of applying heat, a step of coating an edible material on the inner surface of the burger shell 10, i.e. the surrounding surface 111 of the filling compartment 11, and/or on the outer surface of the burger shell 10, such as brushing egg protein portion or oil on the surface of the burger shell 10 to provide a protective layer, so as to prevent the unwanted moisture occurred between the contact of the filling 20 and the burger shell 10.

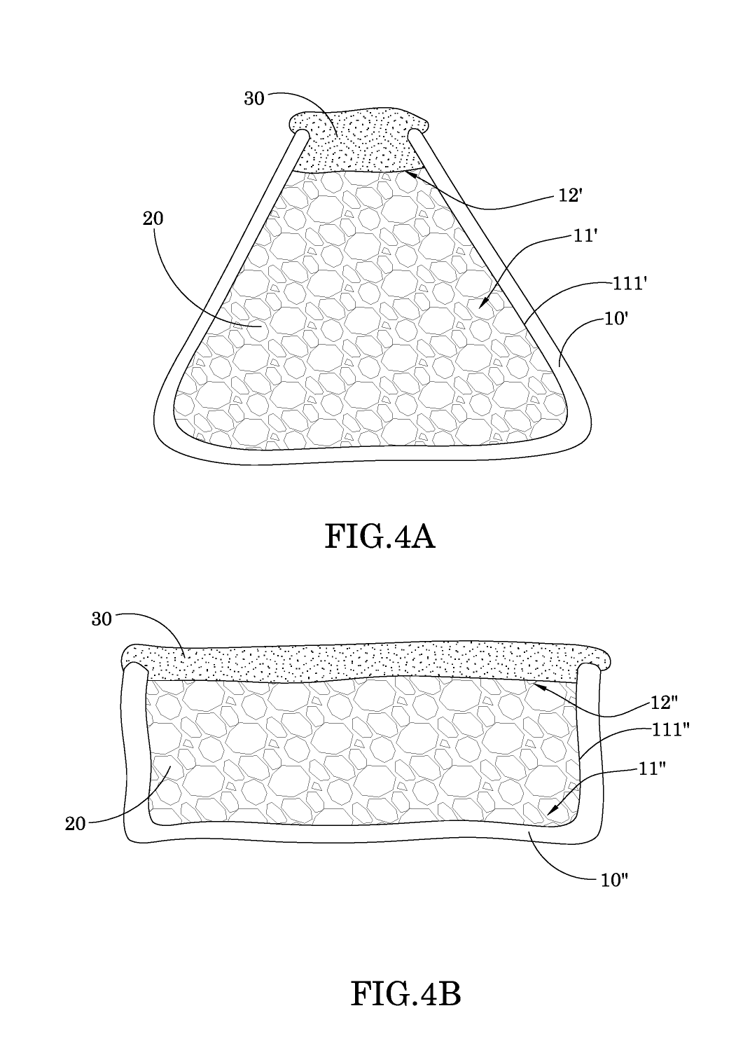

According to the preferred embodiment, the size and the shape of the burger shell 10 can be alternatively configured. As shown in FIG. 4A, the burger shell 10′ has a trapezoid cross section, wherein the surrounding surface 111′ of the filling compartment 11′ has a bottom wall and an inclinedly extended surrounding wall extended from the bottom wall, such that the diameter size of the filling compartment 11′ is gradually reduced from bottom to top. The size of the opening 12′ is smaller than the diameter size of the filling compartment 11′. Therefore, having the trapezoid cross section of the burger shell 10′, more amount of filling 20 can be filled in the bigger filling compartment 11′ and less amount of thick viscous paste 30 can be used for sealing at the smaller opening 12′ of the burger shell 10′.

As shown in FIG. 4B, the burger shell 10″ has a deep pan shape, wherein the surrounding surface 111″ of the filling compartment 11″ has a bottom wall and a surrounding wall perpendicularly extended from the bottom wall, such that the diameter size of the filling compartment 11′ is uniform.

In order to prepare the filling 20, the step (2) further comprises the following steps.

(2.1) Prepare different raw materials, flavor, and/or other predetermined ingredients and nutrition. Accordingly, the ingredients are cut to have a smaller size to be disposed in the filling compartment 11 of the burger shell 10. The ingredients can be a meat product such as chicken, steak, or pork, a seafood product such as fish, shrimp, scallop, and/or vegetable.

(2.2) Cook the ingredients until the ingredients are formed as the edible product. It is worth mentioning that even though the filling 20 is juicy and watery, the filling 20 will not leak out of the burger shell 10 with its physical structure.

In the step (3), the thick viscous paste 30 is made by cooking and mashing a root crop food product, wherein the thick viscous paste is soft enough to be deformed to match with the shape of the opening 12 of the burger shell and is sticky enough to seal at the opening 12 thereof. Accordingly, the root crop food product can be carrot, potato, sweet potato, yam, turnip, and radish to form a mashed carrot, mashed potato, mashed sweet potato, mashed yam, mashed turnip, and mashed radish. It is worth mentioning that the amount of thick viscous paste 30 can be selectively adjusted until the opening 12 of the burger shell 10 is sealed. In addition, the thick viscous paste 30 not only seals at the opening 12 of the burger shell 10 but also contacts with the filling 20 within the filling compartment 11 of the burger shell 10.

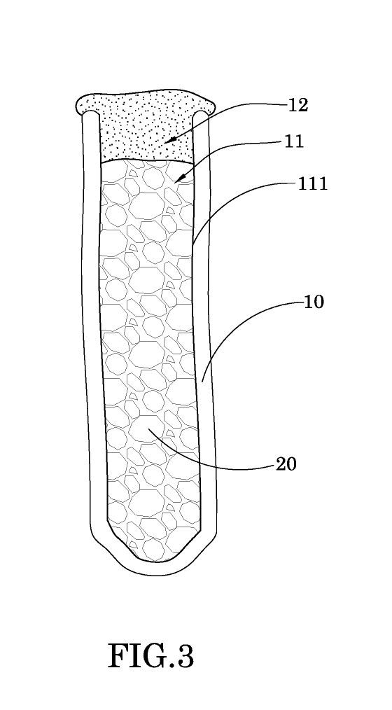

As shown in FIG. 3, when the thick viscous paste 30 is placed at the opening 12 of the burger shell 10, the thick viscous paste 30 not only seals at the inner surface of the burger shell 10, i.e. the inner rim surface thereof, but also seals at the outer surface of the burger shell 10, i.e. the outer rim surface thereof. Therefore, the inner and outer surfaces of the opening rim of the burger rim 10 are stuck by the thick viscous paste 30 to seal the filling 20 within the filling compartment 12 of the burger shell 10. It is worth mentioning that when the burger shell 10 has two openings 12 at two opened ends respectively, the thick viscous pastes 30 can be sealed at two openings 12. Two different kinds of the thick viscous pastes 30 can be used for the two openings 12.

According to the preferred embodiment, the han-burger of the present invention can be freshly made by disposing the filling 20 into the filling compartment 11 of the burger shell 10 and by sealing the opening 12 of the burger shell 10 via the thick viscous paste 30. Therefore, the han-burger of the present invention can be served immediately to the user in the restaurant. Accordingly, the han-burger of the present invention provides a new way to have Chinese food for the consumer to eat Chinese food encased within the burger shell 10. For example, most customers will eat Chinese food “sweet and sour pork” with rice. However, the han-burger of the present invention provides an innovative way for the customers to eat “sweet and sour pork” encased within the burger shell 10. In addition, the customers can enjoy eating the burger shell 10 and the filling 20 therein at the same time as he or she is eating the Chinese food with rice. In other words, the customers are able to select what kind of filling 20 to be disposed in the burger shell 10 and what kind of thick viscous paste 30 to be sealed at the opening 12 of the burger shell 10. The food provider can also provide different types of burger shell 10 for the customers to select as well.

Alternatively, the han-burger of the present invention can also be preserved by freezing the food product to form a frozen food product, wherein the thick viscous paste 30 is frozen to further seal at the opening 12 of the burger shell 10. In other words, the thick viscous paste 30 will be harden after the thick viscous paste 30 is frozen to retain the thick viscous paste 30 at the opening 12 of the burger shell 10 for sealing the filling compartment 11 of the burger shell 10. The user is able to enjoy the han-burger by easily heating up the han-burger via a microwave oven or other conventional heating methods. As the busy life style of the modern people, frozen food has become extremely popular. It is worth mentioning that the present invention also improved the problem of the frozen product, especially for han-burger or the likes, that after being frozen for a while, the burger unit becomes undesirably soggy and tough.

Once the food product is frozen to form the frozen food product, the frozen food product can be packed in a sealed bag 40, wherein a label attached on a surface of the sealed bag for indicating and describing the han-burger, as long as some other information such as expired date and ingredient.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of making a han-burger, comprising the steps of:
(a) forming a burger shell by a dough to have a filling compartment and an opening;
(b) preparing a filling with predetermined ingredients and nutrition, and disposing said filling in said filling compartment of said burger shell through said opening thereof;
(c) preparing a thick viscous paste; and
(d) applying said thick viscous paste to seal said opening of said burger shell to enclose said filling in said filling compartment of said burger shell to form a food product.

2. The method, as recited in claim 1, wherein the step (c) further comprises a step of cooking and mashing a root crop food product to form said thick viscous paste.

3. The method, as recited in claim 2, wherein said root crop food product is selected from a group consisting of carrot, potato, sweet potato, yam, turnip, and radish.

4. The method, as recited in claim 1, wherein the step (a) further comprises a step of applying heat to said burger shell to retain a shape thereof and to harden a surrounding surface of said filling compartment for moisture prevention of said burger shell.

5. The method, as recited in claim 3, wherein the step (a) further comprises a step of applying heat to said burger shell to retain a shape thereof and to harden a surrounding surface of said filling compartment for moisture prevention of said burger shell.

6. The method, as recited in claim 1, wherein a size of said opening of said burger shell is not larger than a diameter size of said filling compartment thereof.

7. The method, as recited in claim 5, wherein a size of said opening of said burger shell is not larger than a diameter size of said filling compartment thereof.

8. The method, as recited in claim 1, further comprising a step of freezing said food product to form a frozen food product, wherein said thick viscous paste is frozen to further seal at said opening of said burger shell.

9. The method, as recited in claim 7, further comprising a step of freezing said food product to form a frozen food product, wherein said thick viscous paste is frozen to further seal at said opening of said burger shell.

10. The method as recited in claim 5 wherein, in the step (a), said burger shell is placed in an oven at a predetermined baking temperature for a predetermined baking time until said burger shell and said burger cover become edible products.

11. The method as recited in claim 9 wherein, in the step (a), said burger shell is placed in an oven at a predetermined baking temperature for a predetermined baking time until said burger shell becomes an edible product.

12. The method as recited in claim 5 wherein, in the step (a), said burger shell is placed in a steam chamber at a predetermined cooking temperature for a predetermined cooking time until said burger shell becomes an edible product.

13. The method as recited in claim 9 wherein, in the step (a), said burger shell is placed in a steam chamber at a predetermined cooking temperature for a predetermined cooking time until said burger shell becomes an edible product.

14. A han-burger, comprising:
a burger shell having a filling compartment and an opening;
a filling with predetermined ingredients and nutrition disposed in said filling compartment of said burger shell through said opening thereof; and
a thick viscous paste placed and sealed at said opening of said burger shell to enclose said filling in said filling compartment of said burger shell to form a food product.

15. The han-burger, as recited in claim 14, wherein said thick viscous paste is mashed root crop food selected from a group consisting of carrots, potato, sweet potato, yam, turnip, and radish.

16. The han-burger, as recited in claim 14, wherein said burger shell has a harden surrounding surface of said filling compartment for moisture prevention of said burger shell.

17. The han-burger, as recited in claim 15, wherein said burger shell has a harden surrounding surface of said filling compartment for moisture prevention of said burger shell.

18. The han-burger, as recited in claim 14, wherein a size of said opening of said burger shell is not larger than a diameter size of said filling compartment thereof.

19. The han-burger, as recited in claim 17, wherein a size of said opening of said burger shell is not larger than a diameter size of said filling compartment thereof.

20. The han-burger, as recited in claim 14, wherein said food product is formed as a frozen food product that said thick viscous paste is frozen to further seal at said opening of said burger shell.

21. The han-burger, as recited in claim 19, wherein said food product is formed as a frozen food product that said thick viscous paste is frozen to further seal at said opening of said burger shell.
